(19) United States
(12) Patent Application Publication
(10) Pub. No.: US 2021/0345184 A1
(43) Pub. Date: Nov. 4, 2021

(54) SIDELINK RESOURCE RESERVATION FOR A USER EQUIPMENT USING A NO-SENSING MODE

(71) Applicant: QUALCOMM Incorporated, San Diego, CA (US)

(72) Inventors: Gabi SARKIS, San Diego, CA (US); Kapil GULATI, Belle Mead, NJ (US); Junyi LI, Franklin Park, NJ (US); Wanshi CHEN, San Diego, CA (US)

(21) Appl. No.: 17/302,443

(22) Filed: May 3, 2021

Related U.S. Application Data
(60) Provisional application No. 63/019,725, filed on May 4, 2020.

(51) Int. Cl. H04W 28/26; H04W 72/04; H04W 74/08

(52) U.S. Cl. CPC H04W 28/26; H04W 74/0808; H04W 72/0446

(57) ABSTRACT

Various aspects of the present disclosure generally relate to wireless communication. In some aspects, a user equipment (UE) may receive, from another UE, information that is to be used to determine one or more resources for use for a sidelink communication. The UE may transmit the sidelink communication using at least one resource that is determined based at least in part on the information. Numerous other aspects are provided.

### CROSS-REFERENCE TO RELATED APPLICATION

This Patent Application claims priority to U.S. Provisional Patent Application No. 63/019,725, filed on May 4, 2020, entitled “SIDELINK RESOURCE RESERVATION FOR A USER EQUIPMENT USING A NO-SENSING MODE,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for sidelink resource reservation for a user equipment (UE) using a no-sensing mode.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a BS via the downlink and uplink. “Downlink” (or “forward link”) refers to the communication link from the BS to the UE, and “uplink” (or “reverse link”) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, or the like.

The above multiple access technologies have been adopted in various telecommunication standards to provide a common protocol that enables different user equipment to communicate on a municipal, national, regional, and even global level. NR, which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication, performed by a user equipment (UE), may include receiving, from another UE, information that is to be used to determine one or more resources for use for a sidelink communication; and transmitting the sidelink communication using at least one resource that is determined based at least in part on the information.

In some aspects, a method of wireless communication, performed by a UE, may include determining information that is to be used by another UE to determine one or more resources for use for a sidelink communication; and transmitting the information to the other UE.

In some aspects, a UE for wireless communication may include a memory and one or more processors coupled to the memory. The one or more processors may be configured to receive, from another UE, information that is to be used to determine one or more resources for use for a sidelink communication; and transmit the sidelink communication using at least one resource that is determined based at least in part on the information.

In some aspects, a UE for wireless communication may include a memory and one or more processors coupled to the memory. The one or more processors may be configured to determine information that is to be used by another UE to determine one or more resources for use for a sidelink communication; and transmit the information to the other UE.

In some aspects, a non-transitory computer-readable medium may store one or more instructions for wireless communication. The one or more instructions, when executed by one or more processors of a UE, may cause the one or more processors to receive, from another UE, information that is to be used to determine one or more resources for use for a sidelink communication; and transmit the sidelink communication using at least one resource that is determined based at least in part on the information.

In some aspects, a non-transitory computer-readable medium may store one or more instructions for wireless communication. The one or more instructions, when executed by one or more processors of a UE, may cause the one or more processors to determine information that is to be used by another UE to determine one or more resources for use for a sidelink communication; and transmit the information to the other UE.

In some aspects, an apparatus for wireless communication may include means for receiving, from another apparatus, information that is to be used to determine one or more resources for use for a sidelink communication; and means for transmitting the sidelink communication using at least one resource that is determined based at least in part on the information.

In some aspects, an apparatus for wireless communication may include means for determining information that is to be used by a UE to determine one or more resources for use for a sidelink communication; and means for transmitting the information to the UE.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, or artificial intelligence-enabled devices). Aspects may be implemented in chip-level components, modular components, non-modular components, non-chip-level components, device-level components, or system-level components. Devices incorporating described aspects and features may include additional components and features for implementation and practice of claimed and described aspects. For example, transmission and reception of wireless signals may include a number of components for analog and digital purposes (e.g., hardware components including antennas, radio frequency (RF) chains, power amplifiers, modulators, buffers, processor(s), interleavers, adders, or summers). It is intended that aspects described herein may be practiced in a wide variety of devices, components, systems, distributed arrangements, or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of sidelink communications, in accordance with the present disclosure.

FIG. 4 is a diagram illustrating an example of sidelink communications and access link communications, in accordance with the present disclosure.

FIG. 5 is a diagram illustrating examples of resource selection using a sensing procedure, in accordance with the present disclosure.

FIGS. 6 and 7 are diagrams illustrating examples of sidelink resource reservation for a UE using a no-sensing mode, in accordance with the present disclosure.

FIGS. 8 and 9 are diagrams illustrating example processes performed, for example, by a UE, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

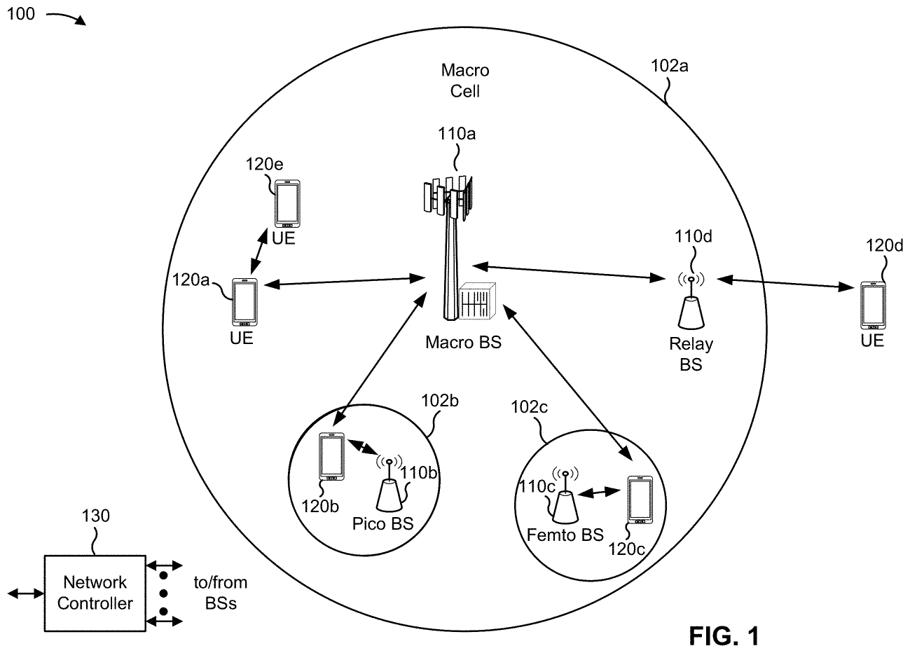

FIG. 1 is a diagram illustrating an example of a wireless network 100, in accordance with the present disclosure. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, or the like.

Wireless network 100 may be a heterogeneous network that includes BSs of different types, such as macro BSs, pico BSs, femto BSs, relay BSs, or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, directly or indirectly, via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, and/or location tags, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components and/or memory components. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As indicated above, FIG. 1 is provided as an example. Other examples may differ from what is described with regard to FIG. 1.

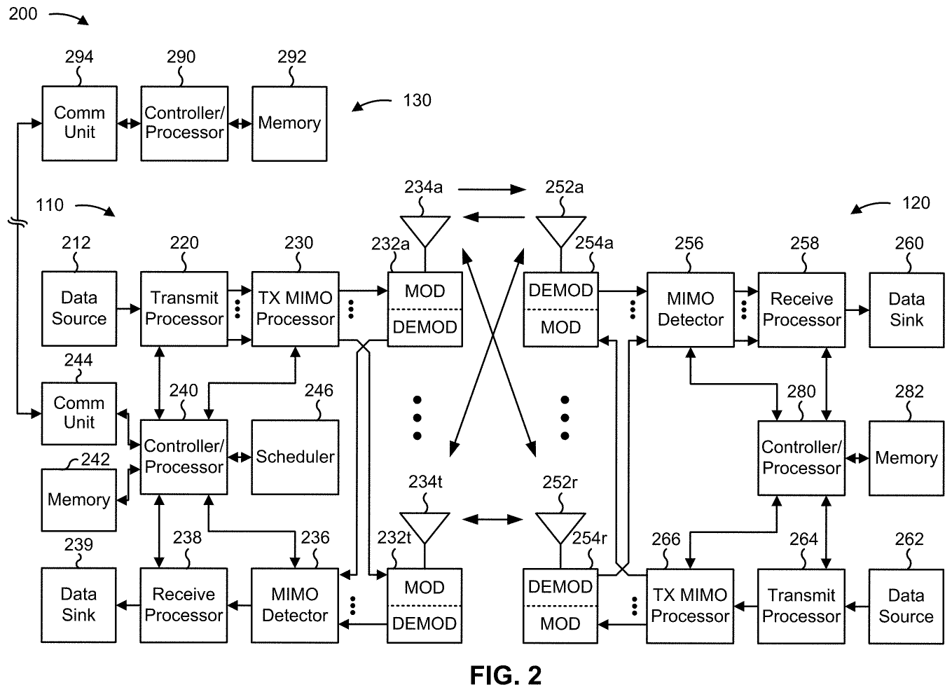

FIG. 2 is a diagram illustrating an example 200 of a base station 110 in communication with a UE 120 in a wireless network 100, in accordance with the present disclosure. Base station 110 may be equipped with T antennas 234a through 234t,and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some aspects, one or more components of UE 120 may be included in a housing.

Network controller 130 may include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

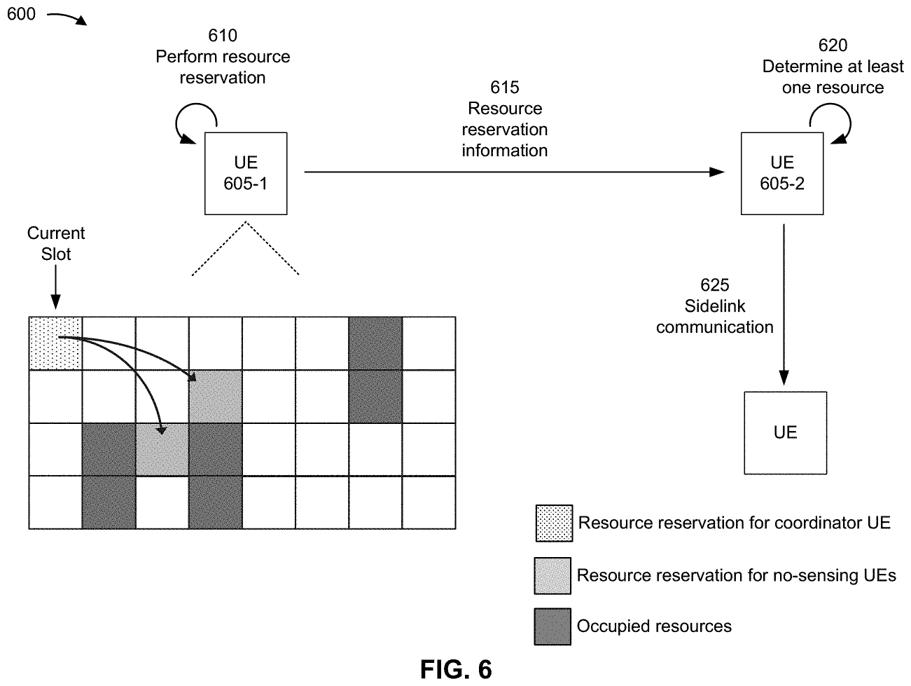

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM), and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein (for example, as described with reference to FIGS. 6-9).

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein (for example, as described with reference to FIGS. 6-9).

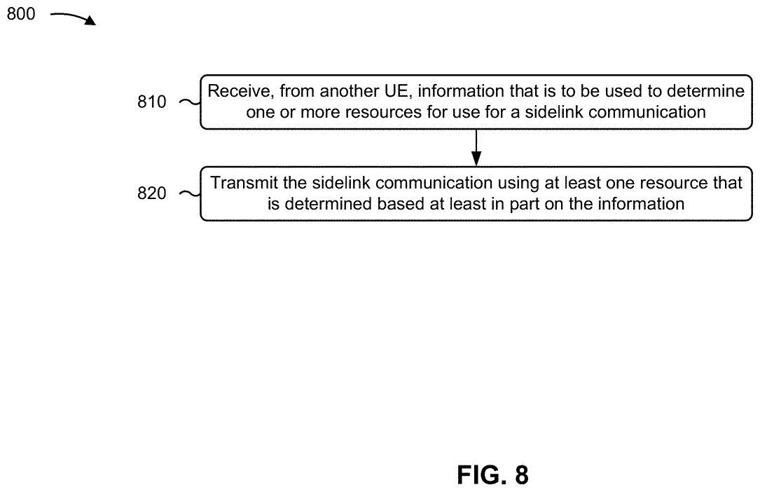

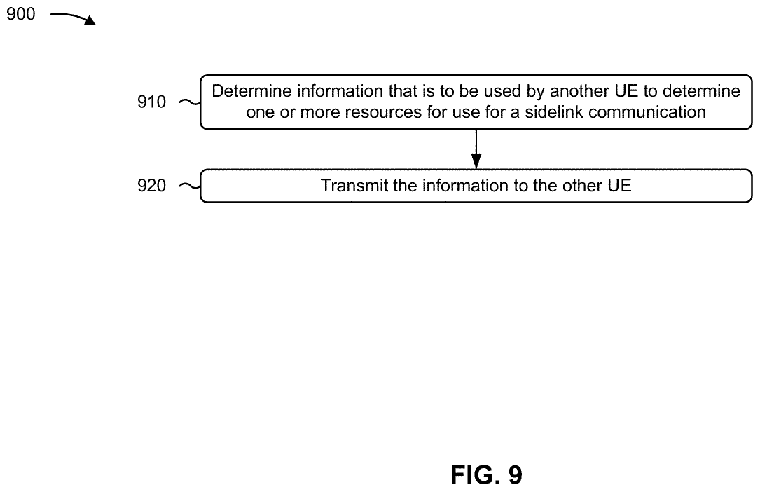

Controller/processor 240 of base station 110, controller/processor 280 of UE 120, and/or any other component(s) of FIG. 2 may perform one or more techniques associated with sidelink resource reservation for a UE using a no-sensing mode, as described in more detail elsewhere herein. For example, controller/processor 240 of base station 110, controller/processor 280 of UE 120, and/or any other component(s) of FIG. 2 may perform or direct operations of, for example, process 800 of FIG. 8, process 900 of FIG. 9, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 800 of FIG. 8, process 900 of FIG. 9, and/or other processes as described herein. In some aspects, executing instructions may include running the instructions, converting the instructions, compiling the instructions, and/or interpreting the instructions, among other examples.

In some aspects, UE 120 may include means for receiving, from another UE, information that is to be used to determine one or more resources that are available for use for a sidelink communication, means for determining at least one resource that is to be used for the sidelink communication based at least in part on the information, means for transmitting the sidelink communication using the at least one resource. In some aspects, UE 120 may include means for determining information that is to be used by another UE to determine one or more resources that are available for use for a sidelink communication, means for transmitting the information to the other UE, and/or the like. In some aspects, such means may include one or more components of UE 120 described in connection with FIG. 2, such as controller/processor 280, transmit processor 264, TX MIMO processor 266, MOD 254, antenna 252, DEMOD 254, MIMO detector 256, receive processor 258, and/or the like.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

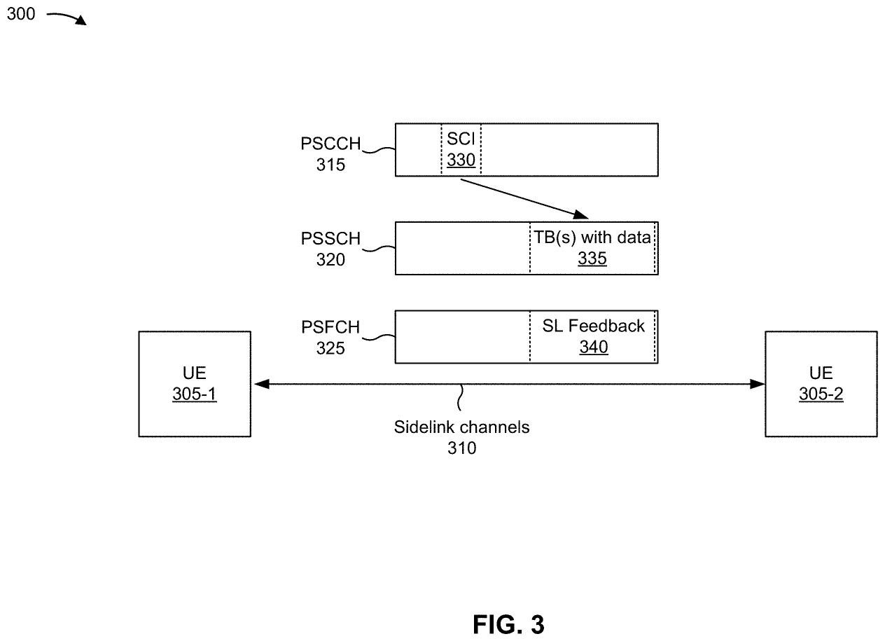

FIG. 3 is a diagram illustrating an example 300 of sidelink communications, in accordance with the present disclosure.

As shown in FIG. 3, a first UE 305-1 may communicate with a second UE 305-2 (and one or more other UEs 305) via one or more sidelink channels 310. The UEs 305-1 and 305-2 may communicate using the one or more sidelink channels 310 for P2P communications, D2D communications, V2X communications (e.g., which may include V2V communications, V2I communications, vehicle-to-pedestrian (V2P) communications, and/or the like), mesh networking, and/or the like. In some aspects, the UEs 305 (e.g., UE 305-1 and/or UE 305-2) may correspond to one or more other UEs described elsewhere herein, such as UE 120. In some aspects, the one or more sidelink channels 310 may use a PC5 interface and/or may operate in a high frequency band (e.g., the 5.9 GHz band). Additionally, or alternatively, the UEs 305 may synchronize timing of transmission time intervals (TTIs) (e.g., frames, subframes, slots, symbols, and/or the like) using global navigation satellite system (GNSS) timing.

As further shown in FIG. 3, the one or more sidelink channels 310 may include a physical sidelink control channel (PSCCH) 315, a physical sidelink shared channel (PSSCH) 320, and/or a physical sidelink feedback channel (PSFCH) 325. The PSCCH 315 may be used to communicate control information, similar to a physical downlink control channel (PDCCH) and/or a physical uplink control channel (PUCCH) used for cellular communications with a base station 110 via an access link or an access channel The PSSCH 320 may be used to communicate data (or in some cases, may be used to communicate second-stage control information), similar to a physical downlink shared channel (PDSCH) and/or a physical uplink shared channel (PUSCH) used for cellular communications with a base station 110 via an access link or an access channel For example, the PSCCH 315 may carry sidelink control information (SCI) 330, which may indicate various control information used for sidelink communications, such as one or more resources (e.g., time resources, frequency resources, spatial resources, and/or the like) where a transport block (TB) 335 may be carried on the PSSCH 320. The TB 335 may include data. The PSFCH 325 may be used to communicate sidelink feedback 340, such as hybrid automatic repeat request (HARQ) feedback (e.g., acknowledgement or negative acknowledgement (ACK/NACK) information), transmit power control (TPC), a scheduling request (SR), and/or the like.

In some aspects, the one or more sidelink channels 310 may use resource pools. For example, a scheduling assignment (e.g., included in SCI 330) may be transmitted in sub-channels using specific resource blocks (RBs) across time. In some aspects, data transmissions (e.g., on the PSSCH 320) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 305 may operate using a transmission mode where resource selection and/or scheduling is performed by the UE 305 (e.g., rather than a base station 110). In some aspects, the UE 305 may perform resource selection and/or scheduling by sensing channel availability for transmissions. For example, the UE 305 may measure an RSSI parameter (e.g., a sidelink-RSSI (S-RSSI) parameter) associated with various sidelink channels, may measure an RSRP parameter (e.g., a PSSCH-RSRP parameter, a PSCCH-RSRP parameter, and/or the like) associated with various sidelink channels, may measure an RSRQ parameter (e.g., a PSSCH-RSRQ parameter) associated with various sidelink channels, and/or the like, and may select a channel for transmission of a sidelink communication based at least in part on the measurement(s).

Additionally, or alternatively, the UE 305 may perform resource selection and/or scheduling using SCI 330 received in the PSCCH 315, which may indicate occupied resources, channel parameters, and/or the like. Additionally, or alternatively, the UE 305 may perform resource selection and/or scheduling by determining a channel busy rate (CBR) associated with various sidelink channels, which may be used for rate control (e.g., by indicating a maximum number of resource blocks that the UE 305 can use for a particular set of subframes).

In some aspects, a first UE 305-1 may transmit coordination information to a second UE 305-2. In this case, the second UE 305-2 may use the coordination information for selecting resources (e.g., so as to avoid or reduce resource collisions) for a sidelink transmission of the second UE 305-2. A UE 305 may transmit coordination information to multiple other UEs 305 and/or a UE 305 may receive coordination information from multiple other UEs 305.

In the transmission mode where resource selection and/or scheduling is performed by a UE 305, the UE 305 may generate sidelink grants, and may transmit the grants in SCI 330. A sidelink grant may indicate, for example, one or more parameters (e.g., transmission parameters) to be used for an upcoming sidelink transmission (e.g., an upcoming sidelink transmission in the same slot as the sidelink grant), such as one or more resource blocks to be used for the upcoming sidelink transmission on the PSSCH 320 (e.g., for TBs 335), one or more subframes to be used for the upcoming sidelink transmission, an MCS to be used for the upcoming sidelink transmission, and/or the like. In some aspects, a UE 305 may generate a sidelink grant that indicates one or more parameters for semi-persistent scheduling (SPS), such as a periodicity of a sidelink transmission. Additionally, or alternatively, the UE 305 may generate a sidelink grant for event-driven scheduling, such as for an on-demand sidelink message.

As indicated above, FIG. 3 is provided as an example. Other examples may differ from what is described with respect to FIG. 3.

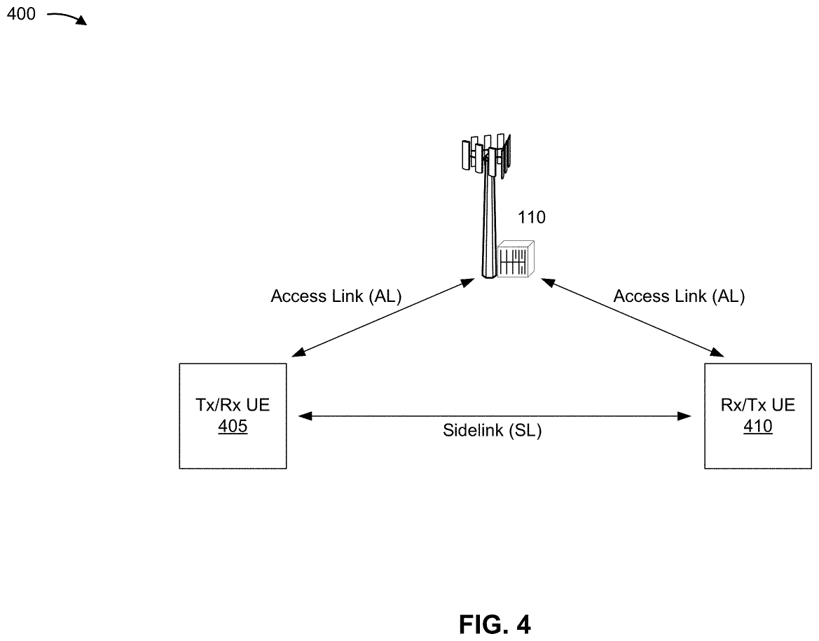

FIG. 4 is a diagram illustrating an example 400 of sidelink communications and access link communications, in accordance with the present disclosure.

As shown in FIG. 4, a transmitter (Tx) UE 405 and a receiver (Rx) UE 410 may communicate with one another via a sidelink, as described above in connection with FIG. 3. As further shown, in some sidelink modes, a base station 110 may communicate with the Tx UE 405 via a first access link. Additionally, or alternatively, in some sidelink modes, the base station 110 may communicate with the Rx UE 410 via a second access link. The Tx UE 405 and/or the Rx UE 410 may correspond to one or more UEs described elsewhere herein, such as the UE 120 of FIG. 1. Thus, a sidelink may refer to a direct link between UEs 120, and an access link may refer to a direct link between a base station 110 and a UE 120. Sidelink communications may be transmitted via the sidelink, and access link communications may be transmitted via the access link. An access link communication may be either a downlink communication (from a base station 110 to a UE 120) or an uplink communication (from a UE 120 to a base station 110).

As indicated above, FIG. 4 is provided as an example. Other examples may differ from what is described with respect to FIG. 4.

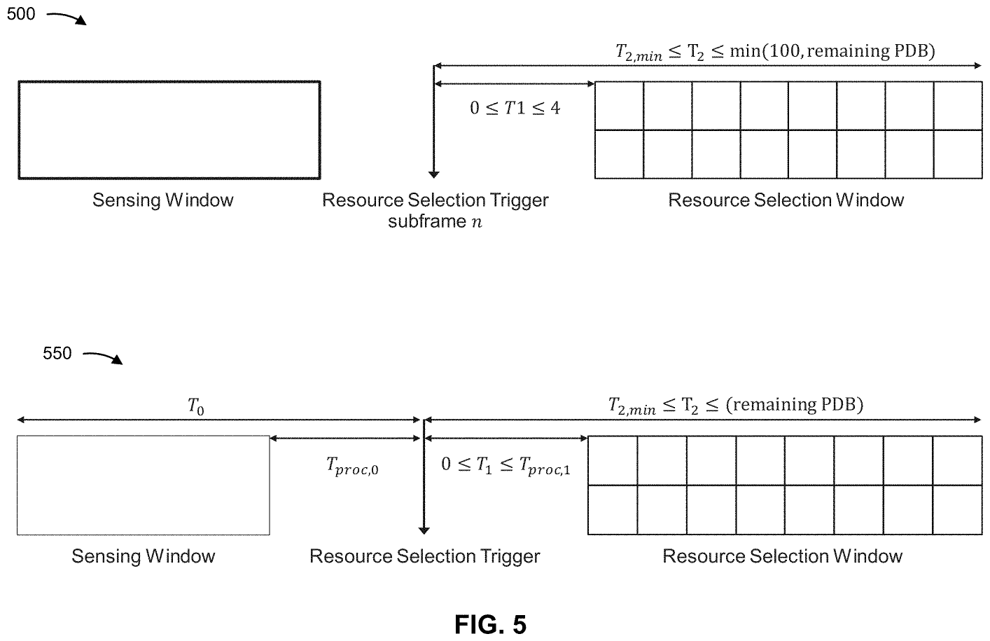

FIG. 5 is a diagram illustrating examples 500 and 550 of resource selection using a sensing procedure, in accordance with the present disclosure.

As shown in FIG. 5, a UE may use a sensing procedure to select resources for sidelink communication, such as described above in connection with FIG. 3. For example, a UE configured for communication in an LTE network may perform the sensing procedure of example 500. As another example, a UE configured for communication in an NR network may perform the sensing procedure of example 550.

As shown in FIG. 5, a UE may perform a sensing procedure in a sensing window. In some cases, the sensing window may be 100 milliseconds (ms) (e.g., for aperiodic resource reservation, such as aperiodic reservation in one or more slots of up to 32 logical slots in the future) or 1100 ms (e.g., for periodic resource reservation). In some cases, a UE configured for communication in an NR network may use a sensing procedure for aperiodic or periodic resource reservation. In some cases, a UE configured for communication in an LTE network may use a sensing procedure for only periodic resource reservation (e.g., which may be limited to a maximum quantity of retransmissions (e.g., two retransmissions) per transport block).

According to the sensing procedure, the UE may decode control messages relating to resource reservations of other UEs, as well as perform measurements (e.g., RSRP measurements) associated with one or more sidelink channels. For example, UEs may transmit reservation information (e.g., in SCI) that indicates a resource reservation for a current slot (e.g., the slot in which the reservation information is transmitted) and for one or more (e.g., up to two) future slots. A resource allocation associated with a resource reservation may be one or more sub-channels in a frequency domain and one slot in a time domain. In some cases, a resource reservation may be aperiodic or periodic. In periodic resource reservation, a UE may signal (e.g., in the reservation information in SCI) a period for the resource reservation (e.g., a value between 0 ms and 1000 ms). Periodic resource reservation may be disabled by configuration in some UEs.

As shown in FIG. 5, the UE may determine to select resources for a sidelink communication based at least in part on a resource selection trigger. For example, resource selection may be triggered when the UE has a packet that is to be transmitted. Based at least in part on the resource selection trigger, the UE may determine one or more resources that are available for selection in a resource selection window. That is, the UE may determine the one or more available resources based at least in part on the sensing procedure performed by the UE. For example, the sensing procedure may provide an indication of resources in the resource selection window that are occupied and/or resources in the resource selection window associated with high interference.

In some cases, if a resource selection trigger occurs in a subframe n, the resource selection window is from n+T₁ to n+T₂. In this case, T₁ may be less than or equal to 4 (e.g., for LTE) or may be less than a processing time (T_{proc,1}) (e.g., for NR). Moreover, T₂ may be greater than or equal to T_{2,min}, which may be a value configured for the UE based at least in part on a priority of the UE, and less than or equal to 100 or a remaining packet delay budget (PDB) of the UE (e.g., for LTE, T₂ may be less than or equal to a minimum of 100 or a remaining PDB, and for NR, T₂ may be less than or equal to a remaining PDB).

In some cases, an extent to which a UE performs a sensing procedure may be based at least in part on a sensing mode used by the UE (e.g., according to a sensing mode configuration). For a full-sensing mode, the UE may perform a sensing procedure for all slots associated with a sensing window. For a partial-sensing mode, the UE may perform a sensing procedure for a subset of slots, subframes, and/or the like, of a sensing window. A sensing procedure in a full-sensing mode or a partial-sensing mode may be performed by the UE over an entire sidelink bandwidth, which may be computationally intensive and consume significant processing resources of the UE. Although a sensing procedure in a partial-sensing mode may conserve some processing resources of the UE, a sensing procedure in a partial-sensing mode may not be suitable for aperiodic resource reservation.

For a no-sensing mode, the UE may not perform a sensing procedure in a sensing window, and may select (e.g., at random) resources in a resource selection window. Accordingly, the UE may determine that all resources in the resource selection window are candidates for selection when using a no-sensing mode, and the UE may report a set of candidates to higher layers for use. UEs operating in a no-sensing mode may experience a high rate of resource collision.

Some techniques and apparatuses described herein enable a UE to perform sidelink communication using a no-sensing mode. In some aspects, the UE may select resources for sidelink communication, and perform sidelink communication using the selected resources, based at least in part on information received from another UE that performs sensing (e.g., as a proxy for the UE). In this way, the UE conserves processing resources, battery resources, and/or the like associated with performing sensing procedures, while improving resource collision rates typically associated with resource selection in a no-sensing mode.

As indicated above, FIG. 5 is provided as an example. Other examples may differ from what is described with respect to FIG. 5.

FIG. 6 is a diagram illustrating an example 600 of sidelink resource reservation for a UE using a no-sensing mode, in accordance with the present disclosure. As shown in FIG. 6, a first UE 605-1 and a second UE 605-2 may communicate with one another. For example, the first UE 605-1 and the second UE 605-2 may communicate on a sidelink channel, as described above in connection with FIG. 3.

In some aspects, a UE 605 may correspond to a UE 120, a UE 305, a UE 405, a UE 410, and/or the like. In some aspects, the first UE 605-1 may be a roadside unit (RSU), a stationary UE, a UE associated with a vehicle, or another UE associated with a higher battery life or otherwise unconstrained by battery life. The first UE 605-1 may be referred to as a coordinator UE. In some aspects, the second UE 605-2 may be a handheld UE, a UE associated with a pedestrian, a portable UE, or another UE associated with a lower battery life or otherwise constrained by battery life. In some aspects, the second UE 605-2 may be operating in a no-sensing mode for sidelink communication. The second UE 605-2 may be referred to as a no-sensing UE.

In some aspects, the coordinator UE 605-1 may be associated with a particular zone (e.g., a geographic zone). The coordinator UE 605-1 may perform resource reservation for no-sensing UEs within the zone. Accordingly, a plurality of coordinator UEs may be respectively associated with a plurality of zones.

As shown in FIG. 6, and by reference number 610, the coordinator UE 605-1 may perform a resource reservation procedure (e.g., as described above in connection with FIG. 3 and/or FIG. 5). For example, the coordinator UE 605-1 may perform a sensing procedure in a sensing window, and may select one or more resources for reservation in a resource selection window, as described above (e.g., the resource reservation may be in accordance with an SCI-1 mechanism).

In connection with the sensing procedure, the coordinator UE 605-1 may reserve a resource in a current slot and may reserve one or more resources in a future slot. The resource reservation in the current slot may be for use by the coordinator UE 605-1. The resource reservation(s) in the future slot(s) may be for use by one or more no-sensing UEs. That is, resource reservation(s) in the future slot(s) may not be for use by the coordinator UE 605-1 (e.g., the resource reservation is a proxy resource reservation in which the coordinator UE 605-1 does not transmit).

In some aspects, the coordinator UE 605-1 may use the resource reservation in the current slot to transmit (e.g., to one or more no-sensing UEs, one or more full-sensing UEs, one or more partial-sensing UEs, and/or the like) a sidelink data communication (e.g., in a sidelink shared channel, such as a PSSCH) or sidelink coordination information. The data communication or the coordination information may be unrelated to the resource reservation(s) in the future slot(s). However, in some aspects, the coordination information may include information relating to the resource reservation(s) in the future slot(s) to enable a UE to perform resource selection and reservation (e.g., resource selection and reservation that avoids the resource reservation(s) in the future slot(s)).

In some aspects, the coordinator UE 605-1 may use the resource reservation in the current slot to transmit (e.g., to one or more no-sensing UEs) information that identifies a location (e.g., a resource allocation) of a message with resource reservation information for no-sensing UEs. The message with the resource reservation information may be a message that is transmitted by the coordinator UE 605-1, another coordinator UE (e.g., associated with another zone, such as a neighboring zone to the zone of the coordinator UE 605-1), and/or the like.

As shown by reference number 615, the coordinator UE 605-1 may transmit a message that includes resource reservation information (e.g., information that is to be used to determine one or more resources for use for a sidelink communication) to the no-sensing UE 605-2 (and/or one or more other UEs). The message may be an SCI message (e.g., that includes a sidelink grant associated with the resource reservation), or the like. The resource reservation information may indicate the resource reservation in the current slot (e.g., that is to be used by the coordinator UE 605-1) and/or the resource reservation(s) in the future slot(s) (e.g., that is to be used by no-sensing UEs). For example, the resource reservation information may indicate a resource reservation using a time resource and a frequency resource associated with the resource reservation.

The coordinator UE 605-1 may transmit the resource reservation information in the same manner in which a UE would transmit resource reservation information when the reserved resources are to be used only by the UE (e.g., when the resources are not reserved by proxy). Accordingly, the message, or another message (e.g., an SCI-2 message), may indicate that the resource reservation(s) in the future slot(s) are to be used by no-sensing UEs. For example, a destination identifier of an SCI message may identify that the resource reservation(s) in the future slot(s) are to be used by no-sensing UEs.

In some aspects, the message that includes the resource reservation information may be associated with a periodic transmission. For example, the coordinator UE 605-1 may periodically transmit messages that include resource reservation information that is to be used by no-sensing UEs. In some aspects, the no-sensing UE 605-2 may receive, from a base station (e.g., BS 110), information indicating a location (e.g., a resource allocation) of the message that includes the resource reservation information. For example, the no-sensing UE 605-2 may receive the information indicating the location in system information (e.g., in a system information block (SIB)) transmitted by the base station.

As shown by reference number 620, the no-sensing UE 605-2 may determine at least one resource that the no-sensing UE 605-2 is to use for sidelink communication based at least in part on the resource reservation information. In some aspects, the no-sensing UE 605-2 may determine the at least one resource based at least in part on a resource assignment (e.g., an explicit resource assignment) for the no-sensing UE 605-2. The resource assignment may identify one or more resources, of the resource reservation(s) in the future slot(s), that are to be used by the no-sensing UE 605-2. The resource assignment may be included in the message that includes the resource reservation information or may be included in another message transmitted by the coordinator UE 605-1 (e.g., a message that includes coordination information).

In some aspects, the no-sensing UE 605-2 may determine the at least one resource by selecting the at least one resource from the resource reservation(s) in the future slot(s). For example, the resource reservation(s) in the future slot(s) may include a plurality of resources, and the no-sensing UE 605-2 may select at least one of the plurality of resources. The no-sensing UE 605-2 may select the at least one resource according to resource selection criteria, may select the at least one resource at random, and/or the like.

As shown by reference number 625, the no-sensing UE 605-2 may transmit a sidelink communication using the at least one resource that is determined. The no-sensing UE 605-2 may transmit the sidelink communication to the coordinator UE 605-1, to another UE, and/or the like. In this way, the coordinator UE 605-1 may perform a sensing procedure and resource reservation on behalf of the no-sensing UE 605-2, so that the no-sensing UE 605-2 does not need to perform a sensing procedure and resource reservation. This may be beneficial when usage of the no-sensing UE 605-2 is constrained by battery life, and usage of the coordinator UE 605-1 is not constrained, or is constrained to a lesser extent, by battery life.

As indicated above, FIG. 6 is provided as an example. Other examples may differ from what is described with respect to FIG. 6.

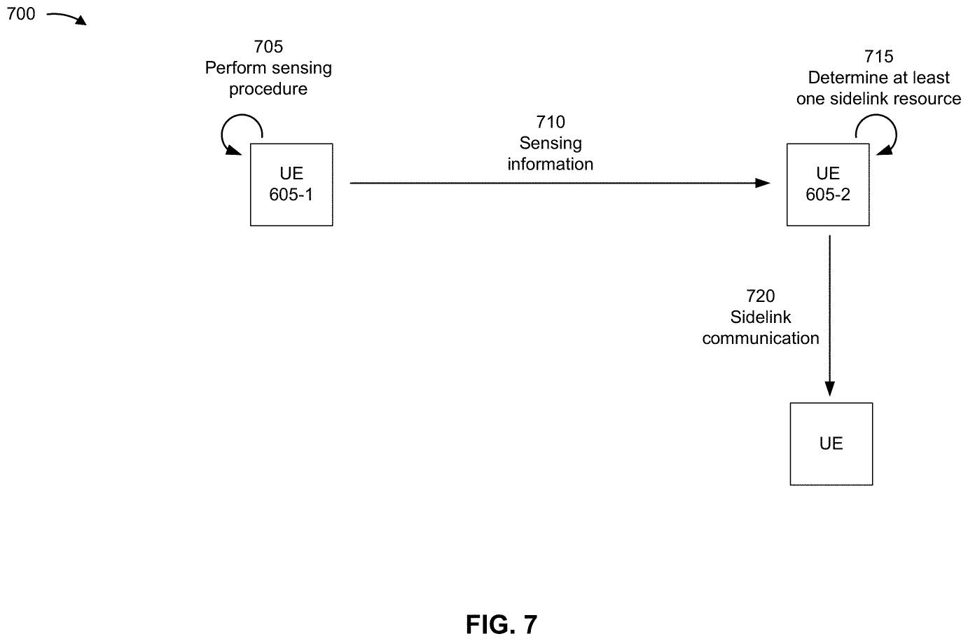

FIG. 7 is a diagram illustrating an example 700 of sidelink resource reservation for a UE using a no-sensing mode, in accordance with the present disclosure.

As shown in FIG. 7, and by reference number 705, the coordinator UE 605-1 may perform a sensing procedure. For example, the coordinator UE 605-1 may perform a sensing procedure (e.g., in a sensing window) that includes determining resources that are occupied and/or performing measurements (e.g., RSRP measurements) in resources.

As shown by reference number 710, the coordinator UE 605-1 may transmit a message that includes sensing information (e.g., information that is to be used to determine one or more resources for use for a sidelink communication) to the no-sensing UE 605-2 (and/or one or more other UEs). The sensing information may be based at least in part on the sensing procedure performed by the coordinator UE 605-1. For example, the sensing information may indicate one or more resources that are occupied (e.g., unavailable for selection by a no-sensing UE) and/or may include information on measurements (e.g., RSRP measurements) performed by the coordinator UE 605-1 in a sensing window. The message that includes the sensing information may be a coordination message, an SCI message, and/or the like.

In some aspects, the message that includes the sensing information may be associated with a periodic transmission. For example, the coordinator UE 605-1 may periodically transmit messages that include sensing information that is to be used by no-sensing UEs. In some aspects, the no-sensing UE 605-2 may receive, from a base station (e.g., BS 110), information indicating a location (e.g., a resource allocation) of the message that includes the sensing information. For example, the no-sensing UE 605-2 may receive the information indicating the location in system information (e.g., in a SIB) transmitted by the base station.

In some aspects, the message that includes the sensing information may include additional information. For example, the message may include information that identifies a location (e.g., a resource allocation) of another message with sensing information for no-sensing UEs. The other message with the sensing information may be a message that is transmitted by the coordinator UE 605-1, another coordinator UE (e.g., associated with another zone, such as a neighboring zone to the zone of the coordinator UE 605-1), and/or the like.

As shown by reference number 715, the no-sensing UE 605-2 may determine at least one resource that the no-sensing UE 605-2 is to use for sidelink communication based at least in part on the sensing information. The no-sensing UE 605-2 may use the sensing information to determine the at least one resource without performing a sensing procedure (e.g., the no-sensing UE 605-2 may use the sensing information in lieu of performing a sensing procedure). For example, the no-sensing UE 605-2 may use the sensing information to select at least one resource for reservation (e.g., in a resource selection window), as described above. In this way, the no-sensing UE 605-2 may use a sensing procedure performed by the coordinator UE 605-1 to determine resources for reservation in the same manner in which a UE would select resources for reservation when the sensing procedure is performed by the UE (e.g., when the sensing procedure is not performed by proxy).

In some aspects, the no-sensing UE 605-2 may transmit a message (e.g., to one or more UEs) that includes resource reservation information based at least in part on the at least one resource that is determined. The message may be an SCI message (e.g., that includes a sidelink grant associated with the resource reservation), and/or the like. The resource reservation information may indicate a resource reservation, by the no-sensing UE 605-2, in a current slot and/or a resource reservation(s), by the no-sensing UE 605-2, in a future slot(s). For example, the resource reservation information may indicate a resource reservation using a time resource and a frequency resource associated with the resource reservation.

As shown by reference number 720, the no-sensing UE 605-2 may transmit a sidelink communication using the at least one resource that is determined (and in accordance with the message that includes the resource reservation information). The no-sensing UE 605-2 may transmit the sidelink communication to the coordinator UE 605-1, to another UE, and/or the like. In this way, the coordinator UE 605-1 may perform a sensing procedure on behalf of the no-sensing UE 605-2, so that the no-sensing UE 605-2 does not need to perform a sensing procedure. This may be beneficial when usage of the no-sensing UE 605-2 is constrained by battery life, and usage of the coordinator UE 605-1 is not constrained, or is constrained to a lesser extent, by battery life.

As indicated above, FIG. 7 is provided as an example. Other examples may differ from what is described with respect to FIG. 7.

FIG. 8 is a diagram illustrating an example process 800 performed, for example, by a UE, in accordance with the present disclosure. Example process 800 is an example where the UE (e.g., UE 120 and/or the like) performs operations associated with sidelink resource reservation for a UE using a no-sensing mode.

As shown in FIG. 8, in some aspects, process 800 may include receiving, from another UE, information that is to be used to determine one or more resources for use for a sidelink communication (block 810). For example, the UE (e.g., using antenna 252, DEMOD 254, MIMO detector 256, receive processor 258, controller/processor 280, and/or the like) may receive, from another UE, information that is to be used to determine one or more resources for use for a sidelink communication, as described above.

As further shown in FIG. 8, in some aspects, process 800 may include transmitting the sidelink communication using at least one resource that is determined based at least in part on the information (block 820). For example, the UE (e.g., using controller/processor 280, transmit processor 264, TX MIMO processor 266, MOD 254, antenna 252, and/or the like) may transmit the sidelink communication using at least one resource that is determined based at least in part on the information, as described above.

Process 800 may include additional aspects, such as any single aspect or any combination of aspects described below and/or in connection with one or more other processes described elsewhere herein.

In a first aspect, the one or more resources are reserved by the other UE.

In a second aspect, alone or in combination with the first aspect, the information identifies the one or more resources reserved by the other UE.

In a third aspect, alone or in combination with one or more of the first and second aspects, the one or more resources are reserved by the other UE in a slot used by the other UE for transmitting a sidelink data communication or coordination information.

In a fourth aspect, alone or in combination with one or more of the first through third aspects, the one or more resources are reserved by the other UE in a slot used by the other UE for transmitting information that identifies a resource allocation for a message with resource reservation information.

In a fifth aspect, alone or in combination with one or more of the first through fourth aspects, the one or more resources reserved by the other UE are not to be used by the other UE.

In a sixth aspect, alone or in combination with one or more of the first through fifth aspects, a message that includes the information indicates that the one or more resources are reserved for UEs that are not performing a sensing procedure.

In a seventh aspect, alone or in combination with one or more of the first through sixth aspects, process 800 includes selecting the at least one resource from the one or more resources.

In an eighth aspect, alone or in combination with one or more of the first through seventh aspects, process 800 includes receiving, from the other UE, a message indicating that the at least one resource is assigned to the UE.

In a ninth aspect, alone or in combination with one or more of the first through eighth aspects, the message is associated with a periodic transmission.

In a tenth aspect, alone or in combination with one or more of the first through ninth aspects, process 800 includes receiving, from a base station, information identifying a resource allocation for the message.

In an eleventh aspect, alone or in combination with one or more of the first through tenth aspects, the information includes sensing information that is based at least in part on a sensing procedure performed by the other UE.

In a twelfth aspect, alone or in combination with one or more of the first through eleventh aspects, the at least one resource is determined based at least in part on the sensing information and without using another sensing procedure.

In a thirteenth aspect, alone or in combination with one or more of the first through twelfth aspects, a message that includes the information is associated with a periodic transmission.

In a fourteenth aspect, alone or in combination with one or more of the first through thirteenth aspects, process 800 includes receiving, from a base station, an indication of a resource allocation for a message that includes the information.

In a fifteenth aspect, alone or in combination with one or more of the first through fourteenth aspects, a message that includes the information also includes information that identifies a resource allocation for another message with sensing information.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a UE, in accordance with the present disclosure. Example process 900 is an example where the UE (e.g., UE 120 and/or the like) performs operations associated with sidelink resource reservation for a UE using a no-sensing mode.

As shown in FIG. 9, in some aspects, process 900 may include determining information that is to be used by another UE to determine one or more resources for use for a sidelink communication (block 910). For example, the UE (e.g., using controller/processor 280, memory 282, and/or the like) may determine information that is to be used by another UE to determine one or more resources for use for a sidelink communication, as described above.

As further shown in FIG. 9, in some aspects, process 900 may include transmitting the information to the other UE (block 920). For example, the UE (e.g., using controller/processor 280, transmit processor 264, TX MIMO processor 266, MOD 254, antenna 252, and/or the like) may transmit the information to the other UE.

Process 900 may include additional aspects, such as any single aspect or any combination of aspects described below and/or in connection with one or more other processes described elsewhere herein.

In a first aspect, process 900 includes reserving the one or more resources.

In a second aspect, alone or in combination with the first aspect, the information identifies the one or more resources reserved by the UE.

In a third aspect, alone or in combination with one or more of the first and second aspects, process 900 includes transmitting a sidelink data communication or coordination information in a slot in which the one or more resources are reserved.

In a fourth aspect, alone or in combination with one or more of the first through third aspects, process 900 includes transmitting information, that identifies a resource allocation for a message with resource reservation information, in a slot in which the one or more resources are reserved.

In a fifth aspect, alone or in combination with one or more of the first through fourth aspects, the one or more resources that are reserved are not to be used by the UE.

In a sixth aspect, alone or in combination with one or more of the first through fifth aspects, a message that includes the information indicates that the one or more resources are reserved for UEs that are not performing a sensing procedure.

In a seventh aspect, alone or in combination with one or more of the first through sixth aspects, the information is to be used by the other UE to select at least one resource from the one or more resources.

In an eighth aspect, alone or in combination with one or more of the first through seventh aspects, process 900 includes transmitting a message indicating at least one resource that is assigned to the other UE.

In a ninth aspect, alone or in combination with one or more of the first through eighth aspects, the message is associated with a periodic transmission.

In a tenth aspect, alone or in combination with one or more of the first through ninth aspects, a resource allocation for the message is to be determined by the other UE based at least in part on an indication received from a base station.

In an eleventh aspect, alone or in combination with one or more of the first through tenth aspects, process 900 includes performing a sensing procedure, and the information includes sensing information that is based at least in part on performing the sensing procedure.

In a twelfth aspect, alone or in combination with one or more of the first through eleventh aspects, the information is to be used by the other UE to determine at least one resource based at least in part on the sensing information and without using another sensing procedure.

In a thirteenth aspect, alone or in combination with one or more of the first through twelfth aspects, a message that includes the information is associated with a periodic transmission.

In a fourteenth aspect, alone or in combination with one or more of the first through thirteenth aspects, a resource allocation for a message that includes the information is to be determined by the other UE based at least in part on an indication received from a base station.

In a fifteenth aspect, alone or in combination with one or more of the first through fourteenth aspects, a message that includes the information also includes information that identifies a resource allocation for another message with sensing information.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

The following provides an overview of some Aspects of the present disclosure:

Aspect 1: A method of wireless communication performed by a user equipment (UE), comprising: receiving, from another UE, information that is to be used to determine one or more resources for use for a sidelink communication; and transmitting the sidelink communication using at least one resource that is determined based at least in part on the information.

Aspect 2: The method of Aspect 1, wherein the one or more resources are reserved by the other UE.

Aspect 3: The method of Aspect 2, wherein the information identifies the one or more resources reserved by the other UE.

Aspect 4: The method of any of Aspects 2-3, wherein the one or more resources are reserved by the other UE in a slot used by the other UE for transmitting a sidelink data communication or coordination information.

Aspect 5: The method of any of Aspects 2-3, wherein the one or more resources are reserved by the other UE in a slot used by the other UE for transmitting information that identifies a resource allocation for a message with resource reservation information.

Aspect 6: The method of any of Aspects 2-5, wherein the one or more resources reserved by the other UE are not to be used by the other UE.

Aspect 7: The method of any of Aspects 2-6, wherein a message that includes the information indicates that the one or more resources are reserved for UEs that are not performing a sensing procedure.

Aspect 8: The method of any of Aspects 1-7, further comprising: selecting the at least one resource from the one or more resources.

Aspect 9: The method of any of Aspects 1-7, further comprising: receiving, from the other UE, a message indicating that the at least one resource is assigned to the UE.

Aspect 10: The method of Aspect 9, wherein the message is associated with a periodic transmission.

Aspect 11: The method of any of Aspects 9-10, further comprising: receiving, from a base station, information identifying a resource allocation for the message.

Aspect 12: The method of Aspect 1, wherein the information includes sensing information that is based at least in part on a sensing procedure performed by the other UE.

Aspect 13: The method of Aspect 12, wherein the at least one resource is determined based at least in part on the sensing information and without using another sensing procedure.

Aspect 14: The method of any of Aspects 1 or 12-13, wherein a message that includes the information is associated with a periodic transmission.

Aspect 15: The method of any of Aspects 1 or 12-14, further comprising: receiving, from a base station, an indication of a resource allocation for a message that includes the information.

Aspect 16: The method of any of Aspects 1 or 12-15, wherein a message that includes the information also includes information that identifies a resource allocation for another message with sensing information.

Aspect 17: A method of wireless communication performed by a user equipment (UE), comprising: determining information that is to be used by another UE to determine one or more resources for use for a sidelink communication; and transmitting the information to the other UE.

Aspect 18: The method of Aspect 17, further comprising: reserving the one or more resources.

Aspect 19: The method of Aspect 18, wherein the information identifies the one or more resources reserved by the UE.

Aspect 20: The method of any of Aspects 18-19, further comprising: transmitting a sidelink data communication or coordination information in a slot in which the one or more resources are reserved.

Aspect 21: The method of any of Aspects 18-19, further comprising: transmitting information, that identifies a resource allocation for a message with resource reservation information, in a slot in which the one or more resources are reserved.

Aspect 22: The method of any of Aspects 18-21, wherein the one or more resources that are reserved are not to be used by the UE.

Aspect 23: The method of any of Aspects 18-22, wherein a message that includes the information indicates that the one or more resources are reserved for UEs that are not performing a sensing procedure.

Aspect 24: The method of any of Aspects 17-23, wherein the information is to be used by the other UE to select at least one resource from the one or more resources.

Aspect 25: The method of any of Aspects 17-23, further comprising: transmitting a message indicating at least one resource that is assigned to the other UE.

Aspect 26: The method of Aspect 25, wherein the message is associated with a periodic transmission.

Aspect 27: The method of any of Aspects 25-26, wherein a resource allocation for the message is to be determined by the other UE based at least in part on an indication received from a base station.

Aspect 28: The method of Aspect 17, further comprising: performing a sensing procedure, wherein the information includes sensing information that is based at least in part on performing the sensing procedure.

Aspect 29: The method of Aspect 28, wherein the information is to be used by the other UE to determine at least one resource based at least in part on the sensing information and without using another sensing procedure.

Aspect 30: The method of any of Aspects 17 or 28-29, wherein a message that includes the information is associated with a periodic transmission.

Aspect 31: The method of any of Aspects 17 or 28-30, wherein a resource allocation for a message that includes the information is to be determined by the other UE based at least in part on an indication received from a base station.

Aspect 32: The method of any of Aspects 17 or 28-31, wherein a message that includes the information also includes information that identifies a resource allocation for another message with sensing information.

Aspect 33: An apparatus for wireless communication at a device, comprising a processor; memory coupled with the processor; and instructions stored in the memory and executable by the processor to cause the apparatus to perform the method of one or more of Aspects 1-16.

Aspect 34: A device for wireless communication, comprising a memory and one or more processors coupled to the memory, the one or more processors configured to perform the method of one or more of Aspects 1-16.

Aspect 35: An apparatus for wireless communication, comprising at least one means for performing the method of one or more of Aspects 1-16.

Aspect 36: A non-transitory computer-readable medium storing code for wireless communication, the code comprising instructions executable by a processor to perform the method of one or more of Aspects 1-16.

Aspect 37: A non-transitory computer-readable medium storing a set of instructions for wireless communication, the set of instructions comprising one or more instructions that, when executed by one or more processors of a device, cause the device to perform the method of one or more of Aspects 1-16.

Aspect 38: An apparatus for wireless communication at a device, comprising a processor; memory coupled with the processor; and instructions stored in the memory and executable by the processor to cause the apparatus to perform the method of one or more of Aspects 17-32.

Aspect 39: A device for wireless communication, comprising a memory and one or more processors coupled to the memory, the one or more processors configured to perform the method of one or more of Aspects 17-32.

Aspect 40: An apparatus for wireless communication, comprising at least one means for performing the method of one or more of Aspects 17-32.

Aspect 41: A non-transitory computer-readable medium storing code for wireless communication, the code comprising instructions executable by a processor to perform the method of one or more of Aspects 17-32.

Aspect 42: A non-transitory computer-readable medium storing a set of instructions for wireless communication, the set of instructions comprising one or more instructions that, when executed by one or more processors of a device, cause the device to perform the method of one or more of Aspects 17-32.

The foregoing disclosure provides illustration and description, but is not intended to be exhaustive or to limit the aspects to the precise forms disclosed.

Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive, from another UE, information that is to be used to determine one or more resources for use for a sidelink communication; and
transmit the sidelink communication using at least one resource that is determined based at least in part on the information.

2. The UE of claim 1, wherein the one or more resources are reserved by the other UE, and the information identifies the one or more resources reserved by the other UE.

3. The UE of claim 2, wherein the one or more resources are reserved by the other UE in a slot used by the other UE for transmitting a sidelink data communication or coordination information.

4. The UE of claim 2, wherein the one or more resources are reserved by the other UE in a slot used by the other UE for transmitting information that identifies a resource allocation for a message with resource reservation information.

5. The UE of claim 2, wherein a message that includes the information indicates that the one or more resources are reserved for UEs that are not performing a sensing procedure.

6. The UE of claim 1, wherein the one or more processors are further configured to:
select the at least one resource from the one or more resources.

7. The UE of claim 1, wherein the one or more processors are further configured to:
receive, from the other UE, a message indicating that the at least one resource is assigned to the UE.

8. The UE of claim 7, wherein the one or more processors are further configured to:
receive, from a base station, information identifying a resource allocation for the message.

9. The UE of claim 1, wherein the information includes sensing information that is based at least in part on a sensing procedure performed by the other UE.

10. The UE of claim 9, wherein the at least one resource is determined based at least in part on the sensing information and without using another sensing procedure.

11. The UE of claim 1, wherein the one or more processors are further configured to:
receive, from a base station, an indication of a resource allocation for a message that includes the information.

12. The UE of claim 1, wherein a message that includes the information also includes information that identifies a resource allocation for another message with sensing information.

13. A UE for wireless communication, comprising:
a memory; and
one or more processors, coupled to the memory, configured to:
determine information that is to be used by another UE to determine one or more resources for use for a sidelink communication; and
transmit the information to the other UE.

14. The UE of claim 13, wherein the one or more processors are further configured to:
reserve the one or more resources,
wherein the information identifies the one or more resources reserved by the UE.

15. The UE of claim 14, wherein the one or more processors are further configured to:
transmit a sidelink data communication or coordination information in a slot in which the one or more resources are reserved.

16. The UE of claim 14, wherein the one or more processors are further configured to:
transmit information, that identifies a resource allocation for a message with resource reservation information, in a slot in which the one or more resources are reserved.

17. The UE of claim 14, wherein the one or more resources that are reserved are not to be used by the UE.

18. The UE of claim 14, wherein a message that includes the information indicates that the one or more resources are reserved for UEs that are not performing a sensing procedure.

19. The UE of claim 13, wherein the information is to be used by the other UE to select at least one resource from the one or more resources.

20. The UE of claim 13, wherein the one or more processors are further configured to:
transmit a message indicating at least one resource that is assigned to the other UE.

21. The UE of claim 13, wherein the one or more processors are further configured to:
perform a sensing procedure,
wherein the information includes sensing information that is based at least in part on performing the sensing procedure.

22. The UE of claim 21, wherein the information is to be used by the other UE to determine at least one resource based at least in part on the sensing information and without using another sensing procedure.

23. The UE of claim 13, wherein a message that includes the information also includes information that identifies a resource allocation for another message with sensing information.

24. A method of wireless communication performed by a user equipment (UE), comprising:
receiving, from another UE, information that is to be used to determine one or more resources for use for a sidelink communication; and
transmitting the sidelink communication using at least one resource that is determined based at least in part on the information.

25. The method of claim 24, wherein the one or more resources are reserved by the other UE, and the information identifies the one or more resources reserved by the other UE.

26. The method of claim 24, wherein the information includes sensing information that is based at least in part on a sensing procedure performed by the other UE.

27. The method of claim 26, wherein the at least one resource is determined based at least in part on the sensing information and without using another sensing procedure.

28. A method of wireless communication performed by a user equipment (UE), comprising:
determining information that is to be used by another UE to determine one or more resources for use for a sidelink communication; and
transmitting the information to the other UE.

29. The method of claim 28, further comprising:
reserving the one or more resources,
wherein the information identifies the one or more resources reserved by the UE.

30. The method of claim 28, further comprising:
performing a sensing procedure,
wherein the information includes sensing information that is based at least in part on performing the sensing procedure.
